(19) United States
(12) Patent Application Publication
(10) Pub. No.: US 2009/0019553 A1
(43) Pub. Date: Jan. 15, 2009

(54) TAGGING PRIVATE SECTIONS IN TEXT, AUDIO, AND VIDEO MEDIA

(75) Inventor: Chandrasekhar Narayanaswami, Wilton, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/775,592

(22) Filed: Jul. 10, 2007

(51) Int. Cl. H04L 9/32

(52) U.S. Cl. 726/28

(57) ABSTRACT

The present invention comprises a method for the creation of designated private segments within a medium stream comprising determining at least one subsection of information content of the media stream that is to be designated as confidential, and granting permission to a party to access the at least one subsection of information content that has been, designated as confidential. The medium stream is delivered and presented to the party, wherein the at least one subsection of information content that has been designated as confidential is not presented to the party. Further, access validation is requested from the party in regard to accessing the at least one subsection of information content that has been designated as confidential and presenting the at least one subsection of information content that has been designated as confidential to the party in response to received access validation.

### BACKGROUND OF THE INVENTION

1. Field of the Invention

This invention relates to the delivery of confidential media information, and particularly to the creation of explicitly designated confidential information indicators within delivered confidential media information.

2. Description of Background

There are many occasions wherein confidential content may be exposed in a public setting before an individual has had a chance to ensure that the situation is acceptable in which to expose the confidential content. For example, an event such as a voice message that is broadcast via a speaker within a group setting, wherein the message contains confidential information. In this situation it may not be appropriate for certain members of the group to listen to particular portions of the broadcast message. As another example, an individual working at a computer workstation that is configured to receive instant messages (IMs) receives an IM while other individuals are present at the workstation. In this instance, confidential information that is delivered to the workstation operator via IM may be viewed by any individual party that is within viewing distance of the displayed IM.

Therefore, there exists a need for a methodology for providing a mechanism that allows an author of a media stream to indicate that a subset of information within the media stream that is being delivered to a receiving party is confidential. As such, the party that is transmitting, the media stream can be assured that any delivered confidential content is appropriately designated and presented to the receiver in a restricted manner.

### SUMMARY OF THE INVENTION

The shortcomings of the prior art are overcome and additional advantages are provided through the provision of a method for the creation and annotation of designated private segments within a medium stream. The method comprises determining a type of medium stream to be delivered to a party, determining at least one subsection of medium information content of the media stream that is to be designated as confidential, and granting permission to a party to access the at least one subsection of medium information content that has been designated as confidential.

The method further comprises delivering the medium stream to the party, presenting the medium stream, wherein the at least one subsection of medium information content that has been designated as confidential is not presented to the party, and requesting access permission validation from the party in regard to accessing the at least one subsection of medium information content, that has been designated as confidential. Yet further, the method comprises receiving the access permission validation from the party; and presenting the at least one subsection of medium information content that has been designated as confidential to the party.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention, are apparent from the following detailed description taken in conjunction with the accompanying drawings in which;

FIG. 1 illustrates a flow diagram detailing a method of tagging and delivering a media stream comprising confidential information.

FIGS. 2 and 3 illustrate one example of an instant messaging dialog window configured to tag selected portions of a text message as confidential.

FIG. 4 Illustrates one example of a digital recording device that is configured to tag selected portions of an audio recording as confidential.

FIG. 5 illustrates one example of a digital camera that is configured to obscure a selected portion of an image as confidential.

FIG. 6A illustrates an example of an image wherein a selected portion of the image has been visually obscured.

FIG. 6B shows the image of FIG. 6A wherein the visual obstruction has been removed from the image.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

Embodiments of the present Invention are directed towards a methodology for implementing a mechanism to enable an author of media stream to annotate or tag sections of information that is contained within the media stream as confidential. Within aspects of the present invention media streams can be formatted as text, audio or video media streams (e.g., a document file, a movie file, a voice memo, a text instant messaging session, a podcast file, an audio song file, web content, etc.), wherein the confidential media stream information can further be marked with a predetermined privacy/confidentiality level. Thus, the segments of media information that are designated as being confidential will not be presented to a recipient unless the recipient takes explicit action to access the secured media information.

Media streams may be created using a plethora, of input devices (e.g., text input devices including personal computers and cell phones, voice recorders, digital cameras, video cameras, etc . . . ). Accordingly, media streams may be delivered to and accessed via a plethora of output devices (e.g., audio video playback systems, personal computers, cell phones etc . . . ). In the event that a media stream is delivered, a recipient must perform specific actions in order to reveal any confidential information that is contained within the media stream. Confidential information retrieval processes will vary depending on the type of media stream that has been delivered.

Within further aspects of the present invention a privacy level may be set for the designate confidential information. As such, text and visual image media stream information can be visually obscured from a viewer. Thus, in regard to text and visual images, a privacy level for any obscured content could be indicated by text tags, colored visually obscuring boxes, or specific font types. A visual obstruction can also be in the form of a generic textual identifier (e.g., the word confidential superimposed over the confidential text or image), art icon, or a geometric shape.

For audio media stream content, during the playback of the media stream a predetermined audio cue or tone can be broadcast to indicate that a confidential audio segment is upcoming, in addition to specifying the privacy level of any confidential audio information. For example, audio cues could be one beep to indicate a lower privacy level, two beeps to indicate a higher privacy level, etc. Further, an audio tone or message can be broadcast in place of the confidential audio segment during the attempted playback of the confidential audio segment (e.g., broadcasting the word “confidential during playback, broadcasting a series of tones, etc . . . ).

Within yet further aspects of the present invention confidential information can be accessed within a media stream by the use of a textual or spoken password or passphrase, a generated encryption key, by presenting a hardware or software token, or by requiring the intended recipient submit a biometric input. Passwords or passphrases can be assigned per the designated privacy level, per obscured term, or per document or media file. Further, passwords or passphrases can comprise a single sign-on password or passphrase, such as a corporate password or passphrase that is specified as being valid for a large subset of content on an intranet. In some eases the passwords or passphrases could be specific to the transacting parties, and thus could be generated in the event that a message is composed.

Actions for the retrieval of confidential text Information or access permission validation information can range from using a mouse (or any other input device, e.g., a click wheel, a touchpad, etc . . . ) to hover a cursor icon over any obscured text within a text message, touching a touch-screen display of the obscured text, or using a mouse to double click a cursor icon situated upon the obscured text. Actions for the retrieval of audio confidential information can include activating a dedicated control on a listening device or activating a play button on the device for a predetermined number of times. Further, actions for the retrieval of displayed confidential image information can include touching a display screen that is displaying an obscured image. Retrieval of confidential sections with higher confidentiality levels for all media types could require multiple input actions, such as clicking a mouse button twice.

Within further exemplary embodiments of the present invention, the confidential segments of media stream information can be encrypted, wherein the encrypting of the confidential media stream segments ensures that unintended recipients of media stream information cannot access the confidential media stream information, if access to the confidential media stream information is provided via a password-passphrase, then the password/passphrase can be utilized to encrypt the confidential media stream segment in further aspects of the present invention, confidential media stream segments can be encrypted via die use of a common generic key that is shared between the transmitter of the media stream and the intended media stream recipient. Once the confidential media stream segment is decrypted a request will be made of the intended recipient to provide a password/passphrase in order to gain access to the confidential media stream information.

During access or playback confidential media stream information is kept encrypted until the media stream reaches the confidential information segment, and then the confidential segment is re-encrypted once the viewing/playback of the confidential segment has ceased. Further, an unintended recipient cannot copy the media stream information from an intended recipient and attempt to access the confidential information via another media viewer/player. For example, consider the instance that the confidential information contained within a textual media stream is copied by an unintended recipient and the unintended recipient attempts to view the media stream within, a text editor in order to view the confidential media stream information, in this event, since the confidential segments of the media stream are encrypted the unintended recipient will not be able to retrieve the confidential media stream information since only the media stream author and the intended recipient have access to the proper media stream decryption key.

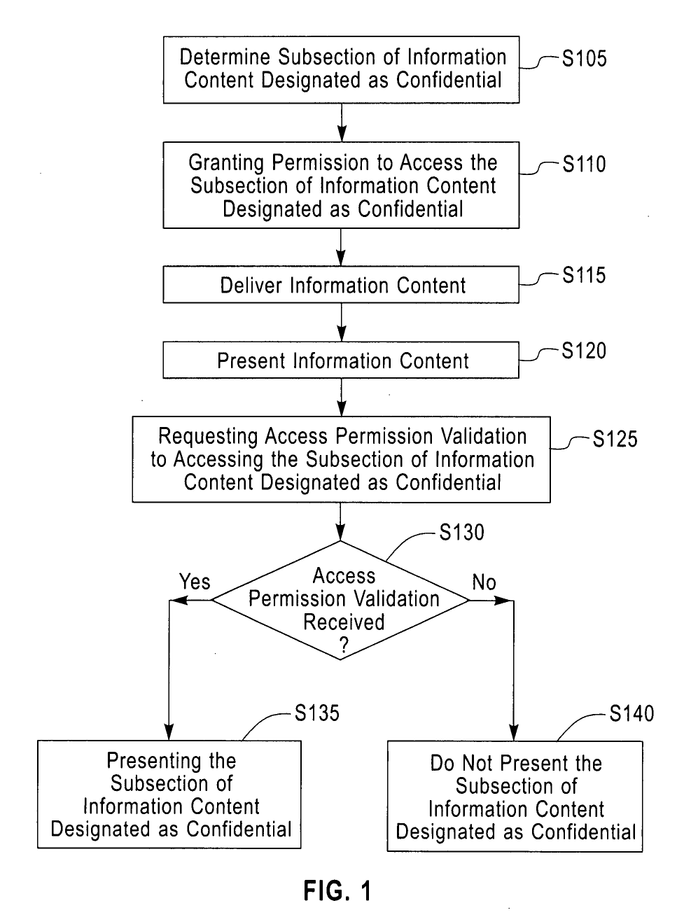

Turning now to the drawings in greater detail, it will be seen that in FIG. 1 there is a flow diagram for a method of designating—or tagging—and delivering a media stream that comprises confidential information. As seen in FIG. 1, at step 105, a determination is made as to what subsection(s) of the media stream information content is to he designated as confidential. At step 110, the access rights to the designated confidential information are granted to an intended recipient using means that are conventional to the granting of the access rights (e.g., the setting of password/passphrases, the generation of an encryption key etc.). Next the media stream content is delivered to the intended recipient (step 115) and thereafter the media stream content is presented to the recipient. At step 120, in the event that the media stream is a text document, image or movie file, then the media stream is displayed to the recipient at an appropriate output device. In the event that the media stream is an audio file, then the media stream is played back to the recipient at an appropriate audio playback device.

The entire delivered media stream content is presented to the recipient except for the subsection(s) of information content that has been designated as being confidential. Any confidential information is presented in limited manner to the recipient, in the event that the confidential information is textual information, then the designated text is visually obscured from display, and in some instances a message is displayed to the recipient indicating that the visually obscured text has been designated as confidential. In the event that the confidential information is in an image or video format, then the designated portion of the displayed image is visually obscured from, display to the recipient.

In the event that the received confidential information is in an audio format, then the designated private segment of the playback message is not broadcast to the listening recipient. Rather, to indicate that confidential information is attempting to playback, in some aspects of the present invention a haptic response can be initiated within the playback device or an audible alert can be broadcast to the recipient to indicate the attempted playback of confidential audio information. At step 125, a request is made to the recipient to provide access permission validation in order to access the confidential media information. At step 130, a determination is made as to if the proper access validation has been received. In the instance that proper access validation has been received from the recipient, and then at step 135 the confidential information content is presented to the recipient. In the instance that proper access validation was not received, then at step 140 the confidential media information is not presented to the recipient.

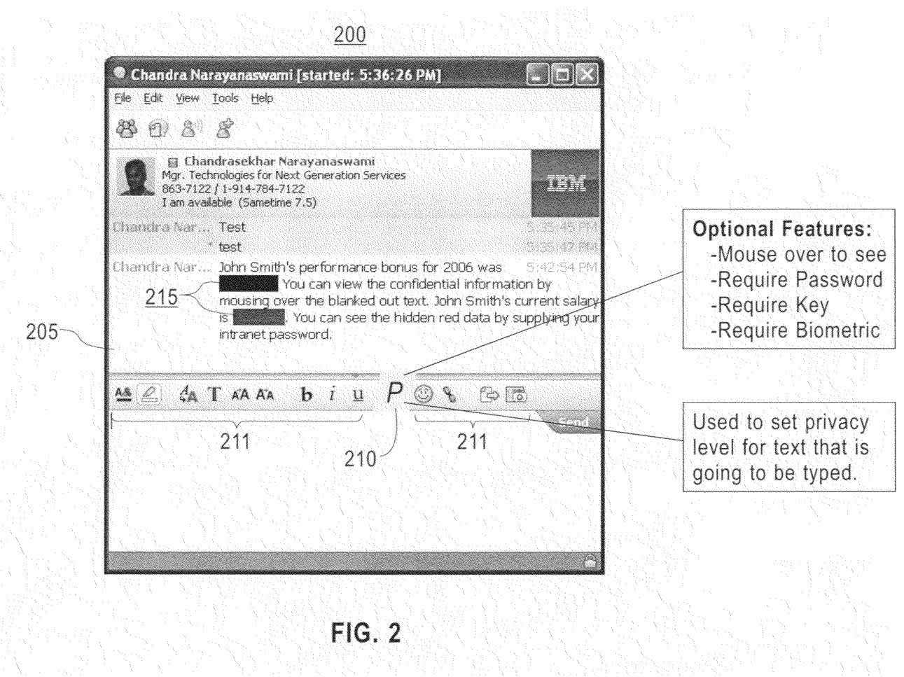

FIGS. 2 and 3 illustrate one example of an instant messaging dialog window 200 that is configured to designate/tag selected portions of a text message media stream as confidential In this Instance an author can create and insert confidentiality and privacy level information into the text information by using the GUI window 200 menu operation selector button 210 that is similar in configuration to operation control buttons 211 (e.g., font and color selector buttons 211) as found in a conventional text or image editor. As shown in FIG. 2, an author can select a desired menu operation, by using an icon selector to either roll-over or “push” the displayed selector button 210. Examples of menu operations can include configuring the media steam content to require the utilization of a password or passphrase, an encryption key, or a biometric input, from the intended recipient.

Within further aspects of the present invention passwords or passphrases can be created at the time the confidential media stream information is created using the menu selector item. 210, wherein the password/passphrase can be conveyed to the intended recipient by any delivery method selected by the media stream author. Additionally, passwords/passphrases can be encrypted by a common encryption key that is shared by the transmitter of the media stream and intended recipient. Tire association between the confidential sections and the passwords can be maintained in some conventional form, of a table or database. Further, these saved associations can be transmitted with the media stream or be retrieved separately.

The visually obscured confidential text 215 is shown graphically as being blocked out from display. The properties of the visual text blockers such as width of the text blocker, and a visual pattern displayed as a text blocker (e.g., a dashed pattern, dotted pattern, hatching pattern, cross-hatching pattern, etc . . . ) can further denote the level of confidentiality of the visually obscured text. A further property includes the visual, text blockers comprising different colors, thus serving as an additional visual indicator that blocked texts can comprise differing privacy levels. As mentioned above, the visual text blocker serving as a visual obstruction can also be in the form of a generic textual identifier (e.g., the word confidential superimposed over the confidential text or image), an icon, or a geometric shape.

As shown in FIG. 3, after a request has been made to enter access validation information and in the event that the intended recipient correctly enters the correct, access permissions, then the information from each visually obscured text 215 can be displayed to the recipient.

As an example of an information confidentiality designation/tagging operation that can be performed within embodiments of the present invention, using a GUI application similar to that, presented within FIGS. 2 and 3, the following message can be created as a text-based message:
Message: Hi Peter, Regarding your question about </priv=2 Joe Woo /priv>, his last 3 PBCs were </priv=3 encrypted(2003=2, 2004=1, 2005=3)/priv>. If you want to assign him to </priv=1 encrypted(project Waterlilly)/priv> you must cheek with </priv=1 encrypted/Mark Foster)/priv>.

In the above formatted message the confidential information of the message is indicated by the placement of privacy tags at the desired text segments using mark-up language protocols. The privacy level of the confidential information is indicated within the tag by a numerical value, while the designated confidential, text is placed between the tag markers. Within further embodiments of the present invention a privacy indicator message and the privacy level indicator can be displayed as the confidential text visual obstruction 215 as an indicator of the presence of confidential textual information. The confidential information is encrypted with an encryption key or password. In some embodiments the confidential information may not be secured by a password but may be marked as private, wherein such content is revealed when the user performs an action such as moving the cursor over the text.

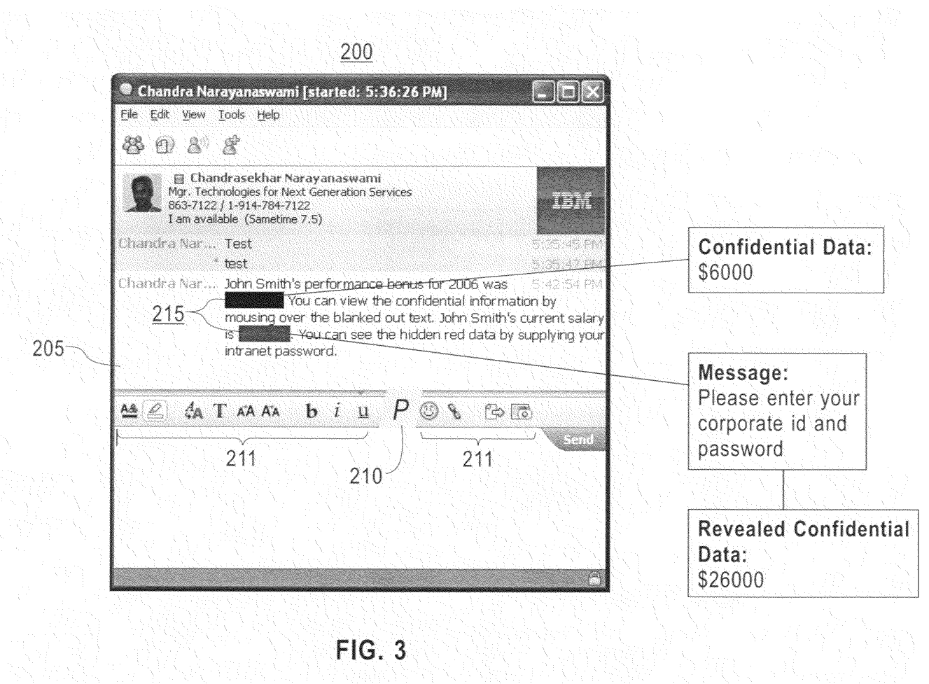

For voice recordings, the individual creating a recording can activate dedicated content, privacy keys on a recording device when a message is being composed by the individual (e.g., at a voice recorder, a telephone, etc . . . ). FIG. 4 illustrates one example of a digital recording device 400 that is configured to designate/tag selected portions of an audio recording as confidential. In regard to audio message media streams, a dedicated information confidentiality indicator control 405 can be implemented within a conventional recording device 400. The purpose of the information confidentiality indicator control 405 is to mark or annotate the audio content in such a manner that the selected audio content is designated as confidential. The information confidentiality indicator control 405 can also be utilized to set the privacy level for the confidential information and the required protocols for accessing the confidential information. During playback of the audio media stream, a playback controller 410 can be utilized to playback the audio stream in addition to accessing privacy setting information in regard to designated confidential information during playback operations.

Within further exemplary embodiments of the present invention textual, line segments corresponding to the audio content of the audio media stream that is being played back can be displayed at a playback device that is equipped with a visual display. Additionally, the displayed line segments of designated confidential information of the audio media stream can be displayed in a color that differs from the non-confidential segments of the played back audio media stream. The properties of line segments such as the color, width, and the visual construction pattern, of a line segment (e.g., a dashed pattern, dotted pattern, a hatching pattern, a cross-hatching pattern, etc . . . ) can further denote the level of confidentiality of the corresponding audio segment. Further, graphical shapes or icons can be displayed to a device operator during playback operations in order to indicate the presence of confidential audio information.

During playback operations, the broadcast of confidential information is muted during the playback of the audio medium stream. Within aspects of the present invention an audio annotation message is associated with the muted confidential information and broadcast in place of the confidential information during the playback. In general, audio annotation messages comprise access permission validation request information that is associated with the muted confidential information content. Further, as mentioned above, the privacy level that is associated with the muted confidential medium information can be indicated by the broadcast of a predetermined series of audio tones or an audio message during the attempted playback of the confidential information.

In yet further aspects of embodiments of the present invention, audio playback devices are configured to perform predetermined haptic response operations in response to the attempted playback of confidential Information. In operation, a haptic instruction annotation is associated, with the confidential audio information content, where in response to the playback of the muted, confidential medium information the haptic instruction annotation initiates a haptic operation within the playback device to indicate the presence of the muted confidential medium information (e.g., by initiating a vibration action within the playback device).

Yet further, a textual annotation message can be associated with the confidential audio information and displayed at a playback device that is equipped with a visual display. Thus, in response to an attempt to playback confidential audio information, a text message can be displayed at the device indicating that the currently play backed content has been designated as confidential. The text message can also comprises access permission validation request information that is associated with the confidential audio information content that the device user will have to enter in order to have access to the confidential information.

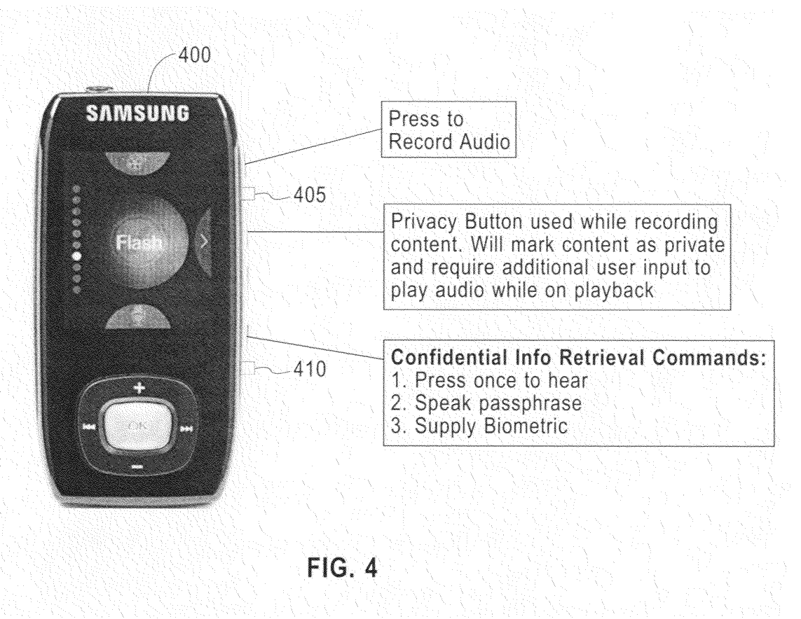

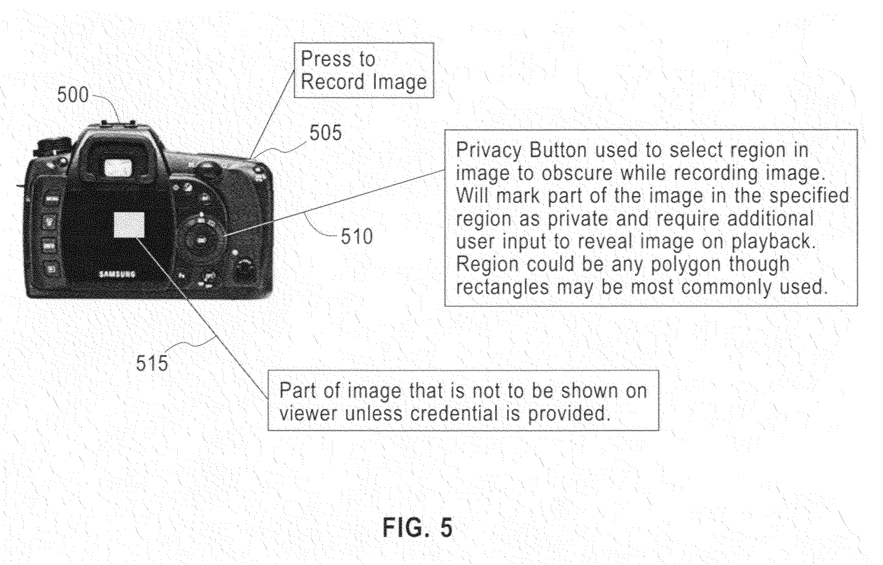

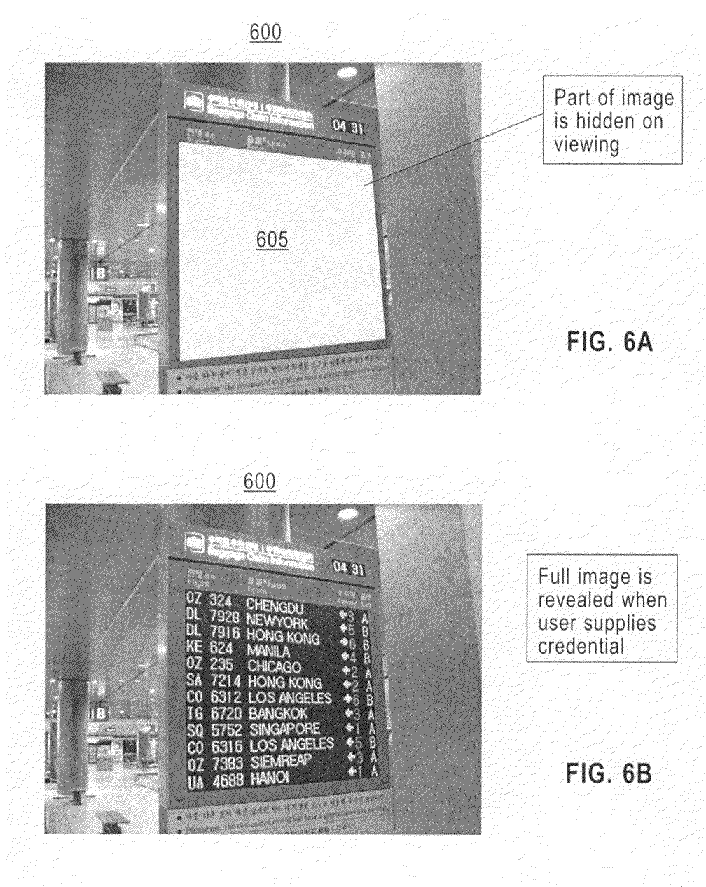

FIG. 5 illustrates one example of a digital camera 500 that is configured to obscure a selected portion of an image that has been designated as confidential. As shown, the camera 500 comprises an image recording button 505 in addition to an information privacy selector button 510. The information privacy selector button is configured to display menu operations pertaining to the size and shape of a visual obstruction 515 that is to be used to block visual access to designated parts of an image. The information privacy selector button 510 is also configured to access and control input to a privacy level selection menu, wherein privacy level and image access control protocols can be set for each designated visual obstruction 515. Once the image media stream is delivered to an intended recipient, the recipient will be prompted to enter desired access validation information in order to access the restricted portions of the displayed image. As seen in FIG. 6A, an example of an image 600 is shown wherein a selected portion of the image 600 has been covered by a visual obstruction 605. FIG. 6B shows the image 600 of FIG. 6A wherein the visual obstruction 605 has been removed horn the image 500.

Within further aspects of embodiments of the present invention an annotation message can be associated with the obscured confidential image content and displayed along with or in place of the visual obstruction. The annotation message comprises access permission validation request information that has been associated with the visually obscured confidential image content. Further, the visual obstruction or the annotated message can be color coded, the color coding signify the privacy level that is associated with the confidential image content.

Within yet further embodiments of the present invention, in the event that a delivered media stream is an audio/video media stream, then the visual portion of the confidential audio/video media stream information is visually obscured and the audio portion of the confidential audio/video media stream information is muted during the playback of the video medium stream. A textual annotation message can be associated with the obscured confidential medium information display, wherein the textual annotation message comprises access permission validation request information that is associated with the visually obscured and muted confidential audio/visual information content. Further, the visual obstruction and the annotated message can be color coded, wherein the color coding is used to signify a privacy level that is associated with the confidential medium information content.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part, of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention, has been described, it will be understood that those skilled, in the art, both now and in the future, may make various improvements and enhancements which fall within the scope of the claims which follow. These claims should be construed to maintain the proper protection for the invention first described.

What is claimed is:

1. A method for the creation and annotation of designated private segments within a medium stream, the method further comprising:
determining a type of medium stream to he delivered;
determining at least one subsection of medium information content of the media stream that is to be designated as confidential;
granting permission to a party to access the at least one subsection of medium information content that has been designated as confidential;
delivering the medium stream to the party;
presenting the medium stream, wherein the at least one subsection of medium information content that has been designated as confidential is not presented to the party;
requesting access permission validation from the party in regard to accessing the at least one subsection of medium information content that has been designated as confidential;
receiving the access permission validation from the party; and
presenting the at least one subsection of medium information content that has been designated as confidential to the party.

2. The method of claim 1, wherein access permission validation information can be retrieved by using an input device to hover a cursor over any displayed obscured text or image media stream information by touching a touch-screen display of the obscured text or image media stream information, or using an input device to double click on a cursor placed upon the obscured text or image media stream information.

3. The method of claim 1, wherein determining at least one subsection of medium information content that is to be designated as confidential further comprises determining a privacy level that is associated with the confidential, medium, information content.

4. The method of claim 1, wherein the medium stream can comprise one or more of a textual medium stream, an audio medium stream, an image medium stream, or a video medium stream,

5. The method of claim 4, where in the event that the medium stream is a textual medium stream or an image medium stream, then the confidential medium information is visually obscured from display, further, an annotation message is associated with the obscured confidential medium information display, wherein the annotation message comprises access permission validation request information that is associated with the visually obscured confidential medium information, content.

6. The method of claim 5, wherein the privacy level that is associated with the confidential medium information content is indicated by a color coding or a visual display pattern of a visual obstruction or an annotated message.

7. The method of claim 4, where in the event that the medium stream is an audio medium stream, then the confidential medium information is muted, during the playback of the audio medium, stream, further, an audio annotation message is associated with the muted confidential medium information, wherein the audio annotation message comprises access permission validation request information that is associated with the touted confidential medium information content.

8. The method of claim 7, wherein the privacy level that is associated with the muted confidential medium information is indicated by the broadcast of a predetermined series of audio tones or an audio message.

9. The method of claim 8, wherein a haptic instruction annotation is associated with the muted confidential medium information content, where in response to the playback of the muted confidential medium information the haptic instruction annotation is utilized to initiate a haptic operation to indicate the presence of the muted confidential medium information.

10. The method of claim 9, wherein a textual annotation message is associated with the muted confidential medium information, wherein the textual annotation message comprises access permission validation request information that is associated with the muted confidential medium information content and is displayed to the party at a display device.

11. The method of claim 4, where in the event that the medium stream is a video medium stream, then the visual portion of the confidential medium information is visually obscured and the audio portion of the confidential medium information is muted during the playback of the video medium stream, further, a textual annotation message is associated with the obscured confidential medium information display, wherein the textual annotation message comprises access permission validation request information that is associated with the visually obscured and muted confidential medium information content.

12. The method of claim 11, wherein the privacy level that is associated with the confidential medium information content is indicated by a color coding or a visual display pattern of a visual obstruction or an annotated message.

13. The method of claim 1, wherein the access permission validation can be accomplished via the submittal of at least one or more of a generated encryption key, a textual password, a textual passphrase, a biometric input, an audio password, an audio passphrase, or presenting a token.

14. A computer program product that includes a computer readable medium useable by a processor, the medium having stored thereon, a sequence of instructions which, when executed by the processor, causes the processor to create, annotate, and deliver designated private segments within a medium stream by:
receiving input in regard to at least one subsection of medium information content that is to be designated as confidential;
granting permission to a party to access the at least one subsection of medium information content that has been designated as confidential;
delivering the medium stream to the party, wherein the at least one subsection of medium information content that has been designated as confidential is not presented to the party;
requesting access permission validation from the party in regard to accessing the at least one subsection of medium information content that has been designated as confidential;
receiving the access permission validation from the party; and
presenting the at least one subsection of medium information content that has been designated as confidential to the party.

15. The computer program product of claim 14, wherein access permission validation information can be retrieved by using an input device to hover a cursor over any displayed obscured text or image media stream information by touching a touch-screen display of the obscured text or image media stream information, or using an input device to double click on a cursor placed upon the obscured text or image media stream information.

16. The computer program product of claim 14, wherein determining at least one subsection of medium, information content that is to be designated, as confidential further comprises determining a privacy level that is associated with the confidential medium, information content.

17. The computer program product of claim 14, wherein the medium, stream can comprise one or more of a textual medium stream, an audio medium stream, an image medium stream, or a video medium stream.

18. The computer program product of claim 17, where in the event that the medium stream is a textual medium stream or an image medium stream, then the confidential medium information is visually obscured from display, further, an annotation message is associated with the obscured confidential medium information display, wherein the annotation message comprises access permission validation request information that Is associated with the visually obscured confidential medium information content.

19. The computer program product of claim 18, wherein the privacy level that is associated with the confidential medium information content is indicated, by a color coding or a visual display pattern of a visual obstruction or an annotated message.

20. The computer program product of claim 17, where in the event that, the medium stream is an audio medium stream, then the confidential medium information is united during the playback of the audio medium stream, further, an audio annotation message is associated with the muted confidential medium information display, wherein the audio annotation message comprises access permission validation, request information that is associated with the muted confidential medium information content.

21. The computer program product of claim 20, wherein the privacy level that is associated with the muted confidential medium information is indicated by the broadcast of a predetermined series of audio tones or an audio message.

22. The computer program product of claim 21, wherein a haptic instruction annotation, is associated with the muted confidential medium information content, where in response to the playback of the muted confidential medium information the haptic instruction annotation is utilized to initiate a haptic operation to indicate the presence of the muted confidential medium information.

23. The computer program product of claim 22, wherein a textual annotation message is associated with the muted confidential medium information, wherein the textual annotation message comprises access permission validation request information that is associated with the muted confidential medium information content and is displayed to the party at a display device.

24. The computer program product of claim 17, where in the event that the medium stream is a video medium stream, then the visual portion of the confidential medium information is visually obscured and the audio portion of the confidential medium information is muted during the playback of the video medium stream, further, an textual, annotation message is associated with the obscured confidential medium information display, wherein the textual annotation message comprises access permission validation request information that is associated with the visually obscured and muted confidential medium information content.

25. The computer program product of claim 24, wherein the privacy level that is associated with the confidential medium information content is indicated by a color coding or a visual display pattern of a visual obstruction or an annotated message.

26. The computer program product of claim 14, wherein the access permission validation can be accomplished via the submittal of at least one or more of a generated encryption key, a textual password, a textual passphrase, a biometric input, an audio password, an audio passphrase, or presenting, a token.
